(19) United States
(12) Patent Application Publication
(10) Pub. No.: US 2007/0052337 A1
(43) Pub. Date: Mar. 8, 2007

(54) Display device

(76) Inventors: Willibrordus A. J. A. Van Der Poel, EINDHOVEN (NL); Tom Van Zutphen, Eindhoven (NL); Harm Albert Wierenga, Eindhoven (NL); Josphus Paulus Augustinus Deeben, Eindhoven (NL); Edward Christiaan Cosman, Eindhoven (NL); Murray Fulton Gillies, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,328

(22) PCT Filed: Nov. 12, 2003
(86) PCT No.: PCT/IB03/05145

§ 371 Date: Jun. 15, 2005

(30) Foreign Application Priority Data
Dec. 17, 2002 (EP) 02080436.5

(51) Int. Cl. H01J 9/02

(52) U.S. Cl. 313/310

(57) ABSTRACT

The invention relates to a display device having under-gate emitters, i.e. emitters where the gates (203) are arranged under the cathodes (205), beneath an insulating layer (204). In order to protect the emitters from a high electric field from an anode (A), an electron guidance element (207) is placed between the emitters and the anode. This allows a relatively low voltage swing to be used for controlling the electron emission from the emitters from the on-state to the off-state.

### TECHNICAL FIELD

The invention relates to a display device comprising a field emission structure having first and second planar, parallel substrates which are spaced apart so as to form a gap therebetween, an anode, which is arranged at the first substrate, a number of cathodes, which are disposed in a plane on the second substrate, on the side facing the first substrate, a number of gate electrodes for controlling electron emission from the cathodes, which gate electrodes are disposed in a plane on the second substrate, under the cathodes, and are separated from the cathodes by an electrically insulating layer.

### BACKGROUND OF THE INVENTION

Such a field emission structure is disclosed in U.S. Pat. No. 6,420,726. In the structure, gate electrodes are formed as parallel strips on a substrate and a continuous layer of insulating material is disposed on top of the gate electrodes. Cathodes are formed as parallel lines on top of the insulating layer, which lines are perpendicular to the lines of the gate electrodes. Since the gate electrodes are disposed on the substrate under the cathodes, the emitter parts of this field emission structure may be called under-gate emitters. The cathode comprises electron emission means such as carbon nanotubes (CNT). An emitter element is provided by an intersection of a given gate electrode line and a given cathode line, which element, when suitably energized, emits electrons from the cathode, which electrons are accelerated in the form of an electron beam towards the anode. As is noted in the document, such a field emission structure may be used in a display device.

A problem with display devices comprising such field emission structures is that the anode field influences the electron emission from the carbon nanotube (CNT) emitters. CNT emitters emit electrons at low field strengths, i.e. at 1-2 V/μm. To be able to modulate the emission, this field strength should be supplied by the gates. A high anode field, e.g. resulting from an anode voltage of 5 kV at 0.5-5 mm distance from the cathode, increases the voltage swing that is needed in order to switch the electron emission on or off. For a high anode field the switch-off voltage at the gate could even be negative with respect to the cathode. Hence, a high anode voltage results in the need for a high drive, i.e. a high voltage swing is needed to modulate the electron emission. Lowering the anode voltage is no useful solution to this problem, since this may lead to divergence of the electron beams, which is undesirable in a display device.

### SUMMARY OF THE INVENTION

An object of the present invention is to provide a display device with an under-gate emitter, where the influence of the anode on the emitter is reduced without lowering the anode voltage (or field) and thus causing beam divergence. The modulation of the electron emission is then effectively determined by the gate voltage only.

This object is realized by a display device, such as a TV, according to the preamble, wherein an electron beam guidance element is provided in the gap between the first and second substrates.

Such an electron beam guidance element substantially protects the emitter element from the influence of the anode voltage. Thus a low gate electrode voltage may be used, without lowering the anode voltage of the display device.

Preferably, the cathodes are parallel cathode strips and the gate electrodes are parallel gate strips, which extend in a direction perpendicular to the cathode strips, such that emitter elements are formed at intersections between cathode strips and gate strips, which emitter elements are addressable by activating the corresponding cathode and gate strips. Preferably, each such emitter element has a corresponding picture element in a display screen, which is associated with the anode, and a corresponding electron guiding funnel in the electron beam guidance element. This allows large but thin display devices to be produced.

Preferably, the electron beam guidance element is a plate extending in a plane which is parallel to the first planar substrate.

In a preferred embodiment a cathode strip comprises a surface broadening in the area of an emitter element. This entails a larger electron emitting area.

Preferably, the cathode strip comprises cut-outs in this surface broadening. This improves the electron emitting capability of the emitter element, since most electrons are emitted from edge portions of the cathode.

In a preferred embodiment the cathode strip in the area of the emitter element has the shape of a ring, or, even more preferred, of at least two concentric rings. Such geometries are suitable in field emission displays.

Alternatively, the cathode strip may be meander-shaped in the area of the emitter element.

Preferably, the cathodes may comprise carbon nanotubes.

In a preferred embodiment a gate strip may comprise a cut-out in the area of an emitter element, which cut-out may preferably substantially correspond to the extension of a corresponding cathode surface in the area of the emitter element, so as to obtain minimal overlap therebetween. This reduces the emitter-gate capacitance, which lowers the energy consumption due to switching losses of the display device.

The insulating layer may be a solid layer, but preferably has two sub-layers with different permittivities (εᵣ), the sub-layer with the highest permittivity being closest to the gate electrodes. This creates a higher field strength at the emitter sites, given the same total insulator thickness and the same applied gate voltage.

In a preferred embodiment the display device further comprises auxiliary gate electrodes, disposed substantially in the same plane as the cathodes. This provides more degrees of freedom in forming the field around the electron emitting area of the cathode.

These and other aspects of the invention will be apparent from and elucidated with reference to the embodiments described hereinafter.

### BRIEF DESCRIPTION OF THE DRAWINGS

FIG. 1 shows a display device according to the prior art,

FIG. 2 shows a display device according to an embodiment of the invention,

FIG. 3 illustrates schematically an electron beam guidance element,

FIGS. 4a, b illustrate schematically an emitter array,

FIG. 5 illustrates an emitter element according to an embodiment where the cathode is provided with cut-outs,

FIG. 6 shows a cathode according to a second embodiment,

FIG. 7 shows a cathode according to a third embodiment,

FIG. 8 shows a cathode according to a fourth embodiment,

FIG. 9 shows an emitter element according to an embodiment of the invention where a solid insulating layer is used,

FIG. 10 shows an emitter element according to another embodiment of the invention where a laminated insulating layer is used,

FIGS. 11a and 11b show emitter elements with means for reduced gate-cathode capacitance.

### DESCRIPTION OF PREFERRED EMBODIMENTS

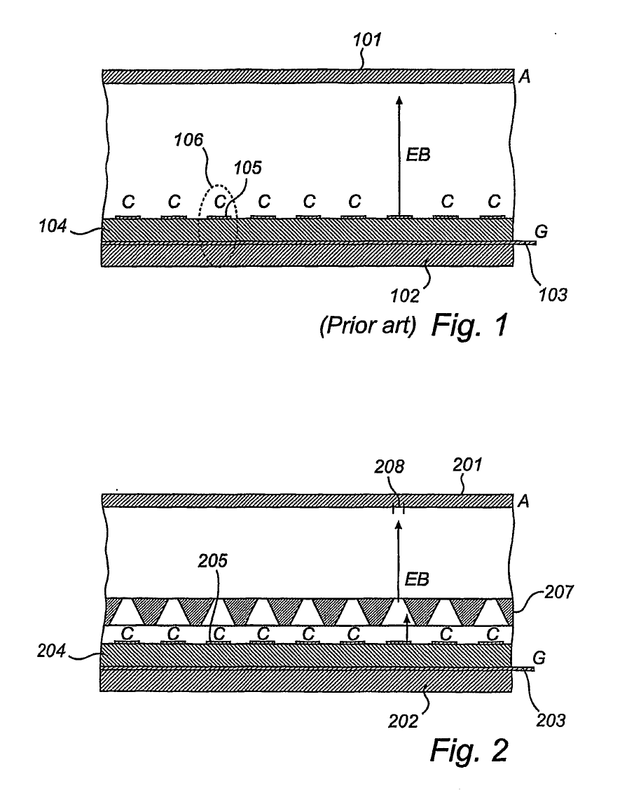

FIG. 1 shows a sectional view of a display device according to the prior art. A first substrate 101 is used as a display screen and is connected to an anode (A). On a second substrate 102, a number of gate electrodes 103 are formed, the section through one of them is shown in the Fig. On top of the gate-electrode layer an insulating layer 104 is disposed, which separates the gate electrodes 103 from a number of cathodes (C) 105 which are formed on the insulating layer 104. The cathodes 105 are strips that extend in a direction perpendicular to the direction of the gate electrode strips 103. At the intersection between a gate electrode strip 103 and a cathode strip 105, an emitter element 106 is provided, such that the gate electrode 103 may be used to control the emission of electrons from the cathode 105 at the area of the emitter element 106. This emitter structure may be called an under-gate emitter, since the gate is placed under the cathode, and has the advantage that the cathodes, which are sensitive, are formed in the last manufacturing step of the display, which provides better production yield.

The first and second substrates 101, 102 are planar and substantially parallel. The space between them is evacuated, such that a vacuum display device is provided. When the local field at the emitter element is such that electrons are emitted, these electrons are accelerated in the form of an electron beam (EB) towards the anode. When the electron beam (EB) impacts on the first substrate 101, the substrate emits light, if it is provided with a phosphorescent material. Thus, by controlling the electron flow from the emitter elements of the display device, the first substrate may display an image.

As mentioned earlier, the display device of FIG. 1 has the drawback that the anode voltage, which must be high (e.g. 5 kV) in order to accelerate the electrons sufficiently, influences the electric field around the emitter element such that high gate drive (swing) voltages must be used in order to properly control the electron flow from the emitter elements. This, of course, leads to a relatively high energy consumption.

FIG. 2 shows a display device according to an embodiment of the invention. This embodiment comprises first and second substrates 201, 202, for instance made of glass, gate electrodes 203, an insulating layer 204, and a number of cathodes 205. An electron guidance element (or hop-plate) 207 is provided between the first and second substrates 201, 202. The first substrate 201 constitutes a screen, which comprises phosphorescent material and a conductive layer, such as an indium tin oxide layer. This layer receives the anode voltage. The distance between the first and second substrates may preferably be in the range 0.5-5 mm and the space between them is sealed and evacuated so as to obtain a vacuum display. The insulating layer 204 may be constituted by insulators such as for instance SiO₂, SiOₓN_{y} (oxynitride), Al₂O₃, or Si₃N₄, and is preferably 1-5 μm thick, but may be thicker.

Electron guidance elements similar to the one described above are known per se from U.S. Pat. No. 5,986,399. In the prior art, such electron guidance elements are, however, used as selection means.

The electron guidance element according to this embodiment of the invention consists of a plate with an array of through-holes, preferably in the form of funnels, where the larger openings face the cathodes and the smaller openings face the anode. One through-hole is provided for each emitter element, i.e. one for each gate strip-cathode strip intersection. This plate is placed 0.01-0.1 mm from the cathodes and shields the emitter elements from the high anode field, so that low gate drive voltages can be used to control electron emission from the cathodes. For each emitter element there is a corresponding through-hole in the plate, and a corresponding picture element (pixel) 208 in the first substrate 201. In this embodiment, when a cathode is kept at earth potential and the anode voltage is 5-15 kV, a gate voltage of 20-100 V (depending on the emitter geometry and the insulator material used) is sufficient to switch an electron beam on, and the gate voltage then only needs to drop to between 0-0.5 times this voltage in order to switch the beam off. A voltage of around 50-400 V may preferably be applied to the hop-plate 207.

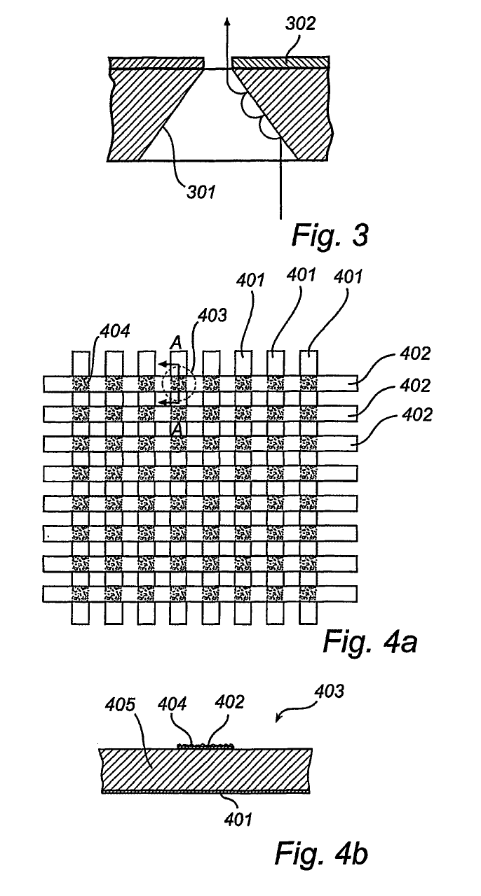

FIG. 3 illustrates schematically in cross-section a part of an electron beam guidance element or hop-plate. The hop-plate is 0.2-0.5 mm thick and consists of an insulator or a high-ohmic semiconductor. The hop-plate comprises an electrode 302 on its top surface. The hop plate, or at least the inner walls 301 of a funnel formed in the plate, is made from an electrically insulating material having such properties that electrons that impact on the inner wall surface result in the emission of secondary electrons. MgO is a preferred insulator material coating for the inner walls of the funnel. These secondary electrons in turn impact on the surface to generate further secondary electrons, or exit the smaller opening that faces the anode. Therefore it may be said that a primary electron results in one or more electrons hopping over the funnel surface towards the exit opening.

Hopping transport of electrons is based on a secondary emission process over charged insulators. The secondary electrons cause charging of the surface, the charge distribution will stabilize to a situation where for each emitted electron that enters the passage of the funnel, on average one electron is emitted from the exit opening. Thus, on average, as many electrons leave the passage as enter it and the electron beam is effectively guided through the passage. This electron-hopping effect is disclosed for instance in U.S. Pat. No. 5,270,611, in “Basics of electron transport over insulators” by S. T. de Zwart, G. G. P. van Gorkom, B. H. W. Hendriks, N. Lambert and P. H. F. Trompenaars, Philips Journal of Research vol. 50 (p. 307-335), 1996, and in “Secondary electron emission properties” by J. J. Scholtz, D. Dijkkamp and R. W. A Schmitz, Philips Journal of Research vol. 50 (p. 375-389), 1996. The arrow in FIG. 3 indicates an electron hopping trace resulting from a primary electron.

FIG. 4a shows schematically an array of emitter elements 403. These elements are formed at intersections between gate strips 401 and cathode strips 402. As mentioned above the gate strips and the anode strips are separated by an electrically insulating layer. Preferably the cathode strips may be provided with means for enhancing the electron emission functionality at the emitter element areas, such as carbon nanotubes 404.

FIG. 4b shows an emitter element 403 in a sectional view along the line A-A in FIG. 4a. The emitter element 403 comprises a cathode strip 402 intersecting with a gate strip 401. An insulating layer 405 separates the gate and the cathode.

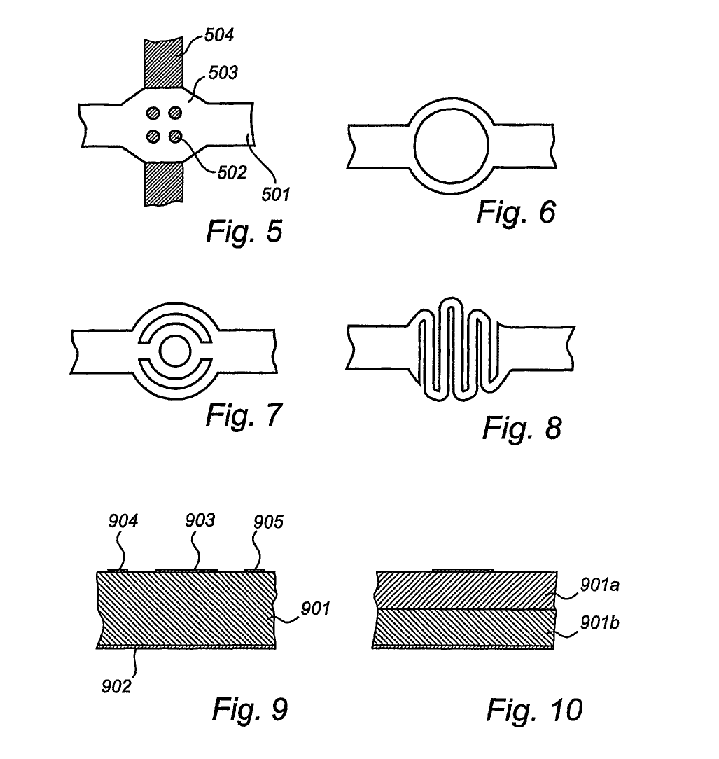

FIG. 5 illustrates in more detail an emitter element according to an embodiment where the cathode strip 501 is provided with cut-outs 502. This enhances the cathode's ability to emit electrons, since electrons are predominantly emitted from the cathode edges, and since the cut-outs provide more edges to the cathode structure. Preferably, the cathode strip also has a surface broadening 503 at the emitter element, i.e. at the intersection with the gate electrode strip 504. This also provides extra edge length to the cathode. Thus, in this embodiment the cathode strips comprise broader parts, interconnected by narrower parts.

FIG. 6 shows a cathode according to another embodiment. In this embodiment the surface broadening and the cut-out are provided in such a way that the cathode at the emitter element is ring-shaped. The outer ring diameter may be around 0.1-0.5 mm, 0.3 mm being preferred, and the ring width may be around 1-100 μm. Thus, in this embodiment the cathode strips comprise ring portions, interconnected by straight parts.

FIG. 7 shows a cathode according to yet another embodiment. In this embodiment the surface broadening and the cut-out are provided in such a way that the cathode at the emitter element has the form of two concentric, interconnected rings. Of course more such rings could be provided.

FIG. 8 shows a cathode according to yet another embodiment, where the cathode is meander-shaped. A comb-shape is another alternative.

FIG. 9 shows an emitter element according to an embodiment of the invention where a solid insulating layer 901 is used to separate the under-gate electrode 902 from the cathode 903. In this embodiment auxiliary gate electrodes 904, 905 are provided, which extend parallel to the cathode strip 903 and in substantially the same plane. The auxiliary gate electrodes may be controlled individually and independently of the under-gate electrode. This provides more possibilities to control the emission field near the cathode, for instance to direct the generated electron beam towards a certain part of the electron beam guidance element, to control the local fields at the CNT emitters more precisely, or to focus the emitted electrons.

FIG. 10 shows an emitter element according to another embodiment of the invention where a laminated insulating layer is used. The insulating layer then comprises at least two sub-layers 901a, 901b with different permittivities εᵣ (dielectric constants), the sub-layer 901b that is closest to the gate electrodes should have the highest permittivity. These insulating layers could be constituted by two of the earlier mentioned materials. This implies a higher field strength at the emitter sites, given the same total insulator thickness and the same voltage applied to the gate.

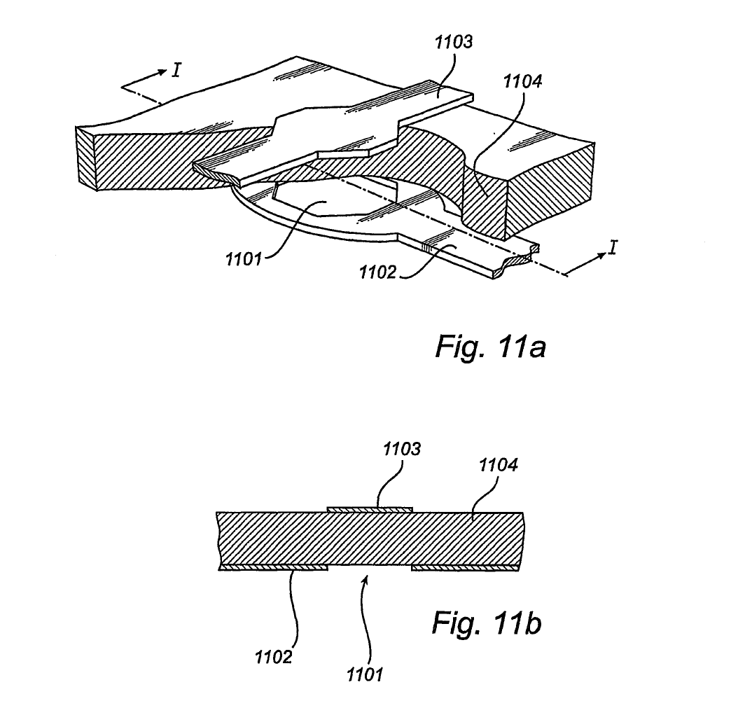

FIGS. 11a and 11b show emitter elements with means for reduced gate-cathode capacitance. FIG. 11a is an exploded perspective view of an emitter element. A cut-out 1101 is provided in the gate electrode 1102, which cut-out substantially corresponds to the extension of the cathode strip 1103 at the emitter element. FIG. 11b shows a sectional view along the line I-I in FIG. 11a. Thus, the gate-cathode overlap for each emitter element is preferably minimized or at least the overlap is reduced. In a preferred embodiment the insulating layer 1104 may be provided with a corresponding cut-out.

These measures reduce the capacitance between the gate and the cathode. The reduced capacitance entails a lower energy consumption, due to smaller switching losses which occur while selecting the emissive elements. Note that the embodiment of the under-gate emitter element described in connection with FIG. 11a,b may preferably be used also in display devices without hop-plates.

In summary, the invention relates to a display device having under-gate emitters, i.e. emitters where the gates are arranged under the cathodes, beneath an insulating layer. In order to protect the emitters from a high electric field from an anode, an electron guidance element is placed between the emitters and the anode. This allows a relatively low voltage swing to be used for controlling the electron emission from the emitters from an on-state to an off-state.

While the invention has been described in connection with various preferred embodiments, it should be understood that the invention should not be construed as being limited to those embodiments. The invention rather includes all variations which could be made thereto by a skilled person and within the scope of the appended claims.

1. A display device comprising a field emission structure having
first (201) and second (202) planar, parallel substrates which are spaced apart so as to form a gap therebetween,
an anode (A), which is arranged at the first substrate,
a number of cathodes (205), which are disposed in a plane on the second substrate (202), on the side facing the first substrate (201),
a number of gate electrodes (203) for controlling electron emission from the cathodes (205), which gate electrodes (203) are disposed in a plane on the second substrate, under the cathodes (205), and are separated from the cathodes by an electrically insulating layer (204),
characterized by an electron beam guidance element (207) being provided in the gap between the first (201) and second (202) substrates.

2. A display device according to claim 1, wherein the cathodes are parallel cathode strips and the gate electrodes are parallel gate strips, which extend in a direction perpendicular to the cathode strips, such that emitter elements are formed at intersections between cathode strips and gate strips, which emitter elements are addressable by activating the corresponding cathode and gate strips.

3. A display device according to claim 2, wherein each such emitter element has a corresponding picture element in a display screen, which is associated with the anode, and a corresponding electron guiding funnel in the electron beam guidance element.

4. A display device according to claim 1, wherein the electron beam guidance element is a plate extending in a plane which is parallel to the first planar substrate.

5. A display device according to claim 2, wherein a cathode strip comprises a surface broadening in the area of an emitter element.

6. A display device according to claim 5, wherein the cathode strip comprises cut-outs in the surface broadening.

7. A display device according to claim 5, wherein the cathode strip in the area of the emitter element has the shape of a ring.

8. A display device according to claim 7, wherein the cathode strip in the area of the emitter element has the shape of at least two concentric rings.

9. A display device according to claim 5, wherein the cathode strip in the area of the emitter element is meander-shaped.

10. A display device according to claim 1, wherein the cathodes comprise carbon nanotubes.

11. A display device according to claim 2, wherein a gate strip comprises a cut-out in the area of an emitter element.

12. A display device according to claim 11, wherein the cut-out of the gate electrode substantially corresponds to the extension of a corresponding cathode surface in the area of the emitter element, so as to obtain minimal overlap therebetween.

13. A display device according to any of the preceding claims, wherein the insulating layer is a solid layer.

14. A display device according to claim 1, wherein the insulating layer has two sub-layers with different permittivities (εᵣ), the sub-layer with the highest permittivity being closest to the gate electrodes.

15. A display device according to claim 1, further comprising auxiliary gate electrodes, disposed substantially in the same plane as the cathodes.
